(19) United States
(12) Patent Application Publication
(10) Pub. No.: US 2012/0116749 A1
(43) Pub. Date: May 10, 2012

(54) AUTOMATIC TRANSLATION DEVICE AND METHOD THEREOF

(75) Inventors: Sung Kwon CHOI, Daejeon (KR); Ki Young LEE, Daejeon (KR); Yoon Hyung ROH, Daejeon (KR); Oh Woog KWON, Daejeon (KR); Young Kil KIM, Daejeon (KR); Chang Hyun KIM, Daejeon (KR); Young Ae SEO, Daejeon (KR); Seong Il YANG, Daejeon (KR); Jinxia HUANG, Daejeon (KR); Yun JIN, Daejeon (KR); Eun Jin PARK, Daejeon (KR); Yingshun WU, Daejeon (KR); Jong Hun SHIN, Busan (KR); Sang Kyu PARK, Daejeon (KR)

(73) Assignee: Electronics and Telecommunications Research Institute, Daejeon (KR)

(21) Appl. No.: 13/198,485

(22) Filed: Aug. 4, 2011

(30) Foreign Application Priority Data
Nov. 5, 2010 (KR) 10-2010-0109611

(51) Int. Cl. G06F 17/28

(52) U.S. Cl. 704/2

(57) ABSTRACT

Provided are an automatic translation device and a method thereof. The automatic translation device includes: a character string error correcting unit correcting an error of an input text; a language simplification processing unit substituting the input text with a simplified input text by applying context based constraints and rules corresponding thereto; and an automatic translation unit translating the simplified input text into an output text. As a result, it is possible to ultimately improve automatic translation quality by mitigating inconvenience of an input text writer due to restriction of a vocabulary using list and a text configuring rule.

### RELATED APPLICATIONS

The present application claims priority to, and the benefit of, Korean Patent Application Serial Number 10-2010-0109611, filed on Nov. 5, 2010, the content of which is hereby incorporated by reference.

### BACKGROUND OF THE INVENTION

1. Field of the Invention

The present invention relates to an automatic translation device and a method thereof, and more particularly, to an automatic translation device and a method thereof that can a produce high-quality translation result.

2. Description of the Related Art

In general, an automatic transmission system can be largely classified into three types according to a base process. Three types include a controlled language based automatic translation system, an automatic translation system including post-processing, and an automatic translation system in which a controlled language and the post-processing are combined with each other.

First, the controlled language based automatic translation system is the automatic translation system that improves readability and translation easiness of a document by restricting a vocabulary using list and a text configuring rule previously defined for an input text from the time of writing the input text to be used.

The automatic translation system has advantages to generate and manage a unified text to increase automatic translation success rate and save translation cost and a translation time by allowing a native speaker and a non-native speaker, but it has disadvantages in that since an input text writer should write the input text according to the vocabulary using list and the text configuring rule, the input text writer may be cumbersome and inconvenient and since a property and a format of the restriction may be different according to a type and a language of the written input text, it may be a little complicated.

Second, the automatic translation system including the post-processing is the automatic translation system that improves the quality of an output text by automatically or manually correcting an error frequently which occurs before automatically translating the input text to the output text and thereafter, outputting the translated text as the output text.

The automatic translation system has advantages to improve automatic translation quality and save translation cost and time by correcting an error which frequently occurs in the existing automatic translation system, while disadvantages in that the post-processing itself is unnecessary or may be incorrectly corrected because the automatic translation result itself has a lot of errors when the translation success rate in the existing automatic translation system is low.

Last, the automatic translation system in which the controlled language and the post-processing are combined with each other is the automatic translation system that corrects an original text based on the controlled language before translation on the basis of the automatic translation system and corrects the translation text on the basis of a post-processing device after translation.

The automatic translation system has both the advantages and the disadvantages of the controlled language based automatic translation system based on the controlled language and the automatic translation system including the post-processing.

### SUMMARY OF THE INVENTION

The present invention has been made in an effort to provide an automatic translation device and a method thereof that can ultimately improve automatic translation quality by mitigating inconvenience of an input text writer due to restriction of a vocabulary using list and a text configuring rule which are disadvantages of a controlled language based automatic translation system.

Further, the present invention has been made in an effort to provide an automatic translation device and a method thereof that can ultimately improve automatic translation quality by previously preventing non-necessity of a post-processing itself and incorrect correction which are disadvantages of an automatic translation system including a post-processing.

An exemplary embodiment of the present invention provides an automatic translation device including: a character string error correcting unit correcting an error of an input text; a language simplification processing unit substituting the input text with a simplified input text by applying context based constraints and rules corresponding thereto; and an automatic translation unit translating the simplified input text into an output text.

The language simplification processing unit may further substitute the input text with a simplified input text by context based constraints and vocabularies corresponding thereto.

The character string error correcting unit may correct at least one of a spelling error, a symbol error, an abbreviation error, a number error, a unit error, a name error, and other errors.

The language simplification processing unit may judge whether each of the context based constraints regarding a sentence length, a sentence pattern, an idiom, disambiguation, and the like of the input text is satisfied and apply each of the rules corresponding thereto according to the judgment result and judge whether each of the context based constraints regarding parts-of-speech of vocabularies of the input text is satisfied and apply each of the vocabularies corresponding thereto according to the judgment result.

Another exemplary embodiment of the present invention provides an automatic translation method including: correcting an error of an input text; substituting the input text with a simplified input text by applying context based constraints and rules corresponding thereto; and translating the simplified input text into an output text.

The substituting of the input text with the simplified input text may further include applying context based constraints and vocabularies corresponding thereto.

At the correcting of the error of an input text, at least one of a spelling error, a symbol error, an abbreviation error, a number error, a unit error, a name error, and other errors may be corrected.

At the substituting of the input text into the simplified input text, whether each of the context based constraints regarding a sentence length, a sentence pattern, an idiom, disambiguation, and the like of the input text is satisfied may be judged and each of rules corresponding thereto may be applied according to the judgment result and at the substituting of the input text into the simplified input text, whether each of the context based constraints regarding parts-of-speech of vocabularies of the input text is satisfied may be judged and each of the vocabularies corresponding thereto may be applied according to the judgment result.

The present invention provides the following effects.

First, there are provided an automatic translation device and a method thereof that can ultimately improve automatic translation quality by mitigating inconvenience of an input text writer due to restriction of a vocabulary using list and a text configuring rule which are disadvantages of a controlled language based automatic translation system.

Second, there is provided an automatic translation device and a method thereof that can ultimately improve automatic translation quality by previously preventing non-necessity of a post-processing itself and incorrect correction which are disadvantages of an automatic translation system including a post-processing.

### BRIEF DESCRIPTION OF THE DRAWINGS

FIG. 1 is an overall configuration diagram or a flowchart of an automatic translation device and a method thereof according to an exemplary embodiment of the present invention;

FIG. 2 is a detailed configuration diagram or a flowchart of a language simplification processor of FIG. 1;

FIG. 3 is a detailed configuration diagram of a character string error corrector of FIG. 2;

FIG. 4 is a detailed flowchart of a context based constraint and simplified rule applying unit of FIG. 2;

FIG. 5 is a diagram showing an application example of FIG. 4;

FIG. 6 is a detailed flowchart of a context based constraint and simplified vocabulary applying unit of FIG. 2;

FIG. 7 is a diagram showing an application example of FIG. 6; and

FIG. 8 is a configuration diagram of an automatic translation unit of FIG. 1.

### DETAILED DESCRIPTION OF THE EMBODIMENTS

In exemplary embodiments described below, components and features of the present invention are combined with each other in a predetermined pattern. Each component or feature may be considered to be optional unless stated otherwise. Each component or feature may not be combined with other components or features. Further, some components and/or features are combined with each other to configure the exemplary embodiments of the present invention. The order of operations described in the exemplary embodiments of the present invention may be modified. Some components or features of any exemplary embodiment may be included in other exemplary embodiments or substituted with corresponding components or features of other exemplary embodiments.

The exemplary embodiments of the present invention may be implemented through various means. For example, the exemplary embodiments of the present invention may be implemented by hardware, firmware, software, or combinations thereof.

In the case of implementation by hardware, a method according to the exemplary embodiment of the present invention may be implemented by application specific integrated circuits (ASICs), digital signal processors (DSPs), digital signal processing devices (DSPDs), programmable logic devices (PLDs), field programmable gate arrays (FPGAs), a processor, a controller, a microcontroller, a microprocessor, and the like.

In the case of implementation by firmware or software, the method according to the exemplary embodiments of the present invention may be implemented in the form of a module, a process, or a function of performing the functions or operations described above. Software codes may be stored in a memory unit and driven by a processor. The memory unit is positioned inside or outside of the processor to transmit and receive data to and from the processor by a previously known various means.

Predetermined terms used in the following description are provided to help understanding the present invention and the use of the predetermined terms may be modified into different forms without departing from the spirit of the present invention.

Further, a description of functions and structures of components of an automatic translation device according to the present invention can be adopted in an automatic translation method according to the present invention as it is.

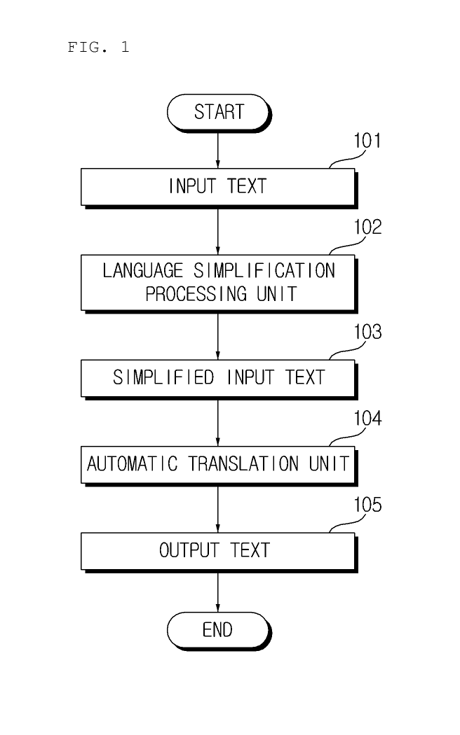

FIG. 1 is an overall configuration diagram or a flowchart of an automatic translation device and a method thereof according to an exemplary embodiment of the present invention. Referring to FIG. 1, a language simplification processing unit 102 receives an input text 101 configured by a first language, and converts and outputs the corresponding input text into a simplified input text 103. An automatic translation unit 104 receives the simplified input text 103, and translates and outputs the received input text into an output text 105 configured by a second language other than the first language.

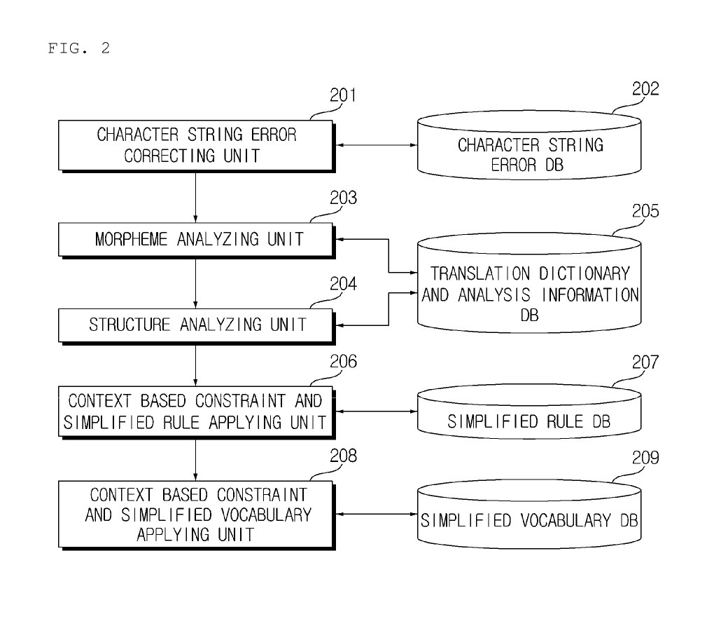

FIG. 2 is a detailed configuration diagram or a flowchart of a language simplification processor of FIG. 1. Referring to FIG. 2, the language simplification processing unit 102 includes a character string error correcting unit 201 correcting an error of the input text 101 by using a character string error DB 202 when the error related with the character string of the inputted input text 101 exists, and a morpheme analyzing unit 203 and a structure analyzing unit 204 analyzing a morpheme and analyzing a sentence structure by using a translation dictionary and an analysis information DB 205, respectively. Herein, the character string error correcting unit 201 may be separated from the language simplification processing unit 102 and may be included in the language simplification processing unit 102, but they are different from each other in terms of their configurations, however, they are the same as each other in terms of their functions.

Further, the language simplification processing unit 102 according to the present invention includes a context based constraint and simplified rule applying unit 206 simplifying an input text having a tree structure which is outputted from the structure analyzing unit 204 and substituting the simplified input text with an unambiguous sentence by using a simplified rule DB 207 storing context based constraints and rules corresponding thereto.

Furthermore, the language simplification processing unit 102 may further include a context based constraint and simplified vocabulary applying unit 208 substituting vocabularies in the input text having the tree structure which is outputted from the structure analyzing unit 204 or the input text outputted from the context based constraint and simplified rule applying unit 206 with simplified and unambiguous vocabularies by using the simplified vocabulary DB 209 storing the context based constraints and the vocabularies corresponding thereto. Herein, in the exemplary embodiment, the context based constraint and simplified rule applying unit 206 and the context based constraint and simplified vocabulary applying unit 209 are sequentially applied, but the application sequence may be changed as necessary.

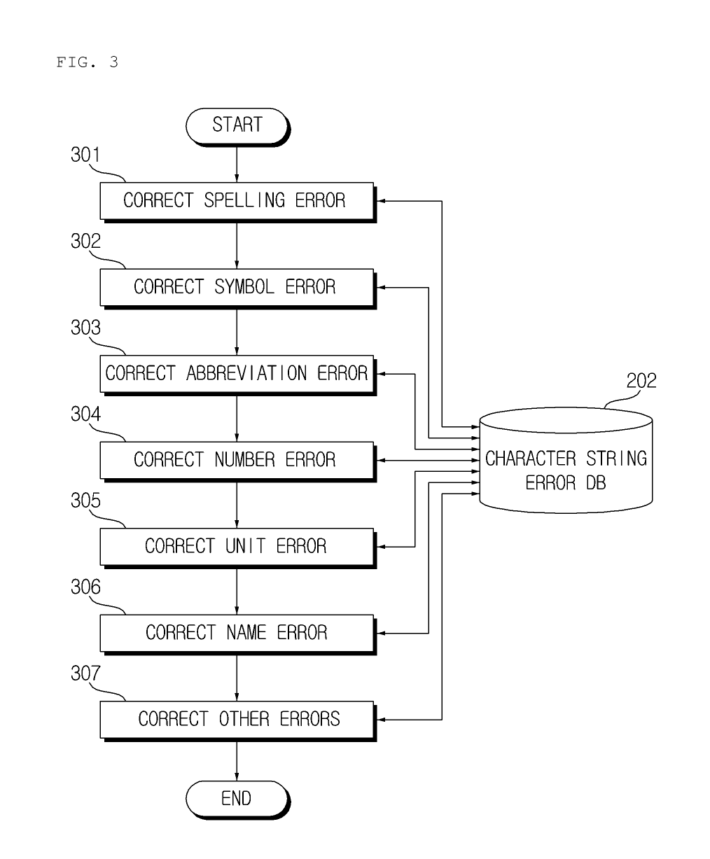

FIG. 3 is a detailed configuration diagram of a character string error corrector of FIG. 2. Referring to FIG. 3, the character string error correcting unit 201 performs spelling error correction 301 when a spelling error exists in an inputted input text, performs symbol error correction 302 when a symbol error exists, performs abbreviation error correction 303 when an abbreviation error exists, performs number error correction 304 when a number error exists, performs unit error correction 305 when a unit error exists, performs name error correction 306 when a name error such as a proper name exists, and performs other error correction 307 when other errors exist by using the character string error DB 202. Herein, the performed various error corrections are not limited to their sequences. Further, since the error corrections are performed only when the errors exist, all the error corrections may be performed or not performed and only some of them may be performed. Of course, only some of them may be applied.

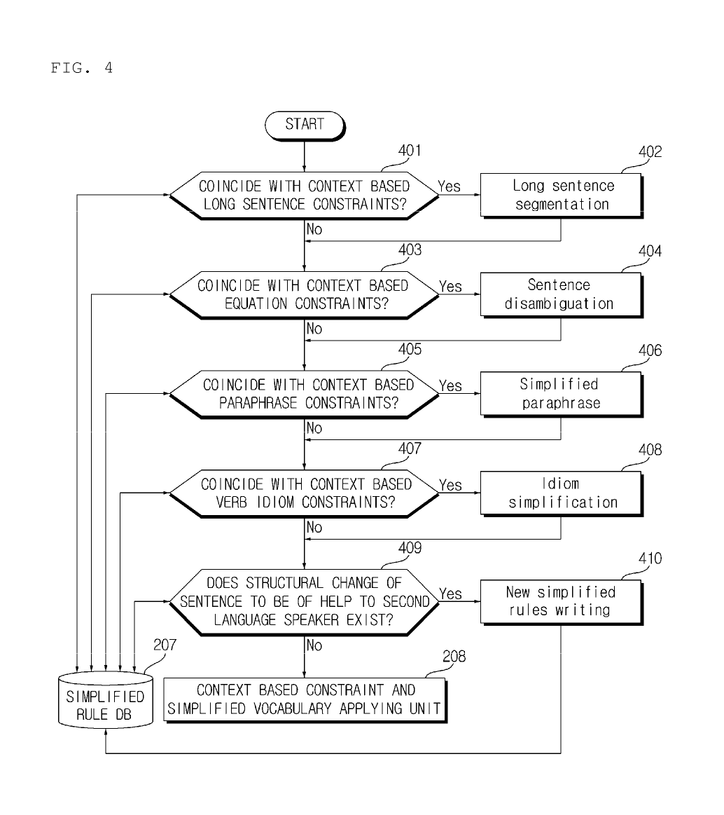

FIG. 4 is a detailed flowchart of a context based constraint and simplified rule applying unit of FIG. 2. Referring to FIG. 4, the context based constraints and simplified rule applying unit 206 replaces a complicated and ambiguous input text with a clear sentence by using the simplified rule DB 207 storing the context based constraints and the rules corresponding thereto. In other words, at each judgment step of judging whether the inputted input text coincides with the context based constraints, the input text which coincides with the constraints is substituted with a more simple sentence.

For example, at judging whether the input text coincides with context based long sentence constraints (401), it is judged whether the input text coincides with the long sentence constraints and when the input text coincides with the long sentence constraints, long sentence segmentation 402 is made. When the input text does not coincide with the long sentence constraints, the next judgment step is performed.

Similarly, at judging whether the input text coincides with context based equation constraints (403), it is judged whether the input text coincides with the equation constraints and when the input text coincides with the equation constraints, sentence disambiguation 404 is made. If not, the next judgment step is performed. Subsequently, at judging whether the input text coincides with context based paraphrase constraints (405), when the input text coincides with the paraphrase constraints, simplified paraphrase 406 is performed. If not, the next judgment step is performed. Further, at judging whether the input text coincides with context based verb idiom constraints (407), it is judged whether the input text coincides with context based verb idiom constraints and when the input text coincides with the context based verb idiom constraints, idiom simplification 408 is performed and when the input text does not coincide with the context based verb idiom constraints, the next judgment step is performed.

Last, at judging whether a structural change to be of help to a second language speaker exists (409), as a step of making a new rule by judgment of an input text write when the simplification rule is not applied, when a new simplified rule should be added, new simplified rules writing 410 is performed and if not, a judgment step in the context based constraint and simplified rule applying unit 206 and performing the rule corresponding thereto are finished and the process proceeds to the context based constraint and simplified vocabulary applying unit 208. Herein, since the performing sequence of the rules is arbitrarily set merely for description of the exemplary embodiment, the performing sequence may be changed as necessary.

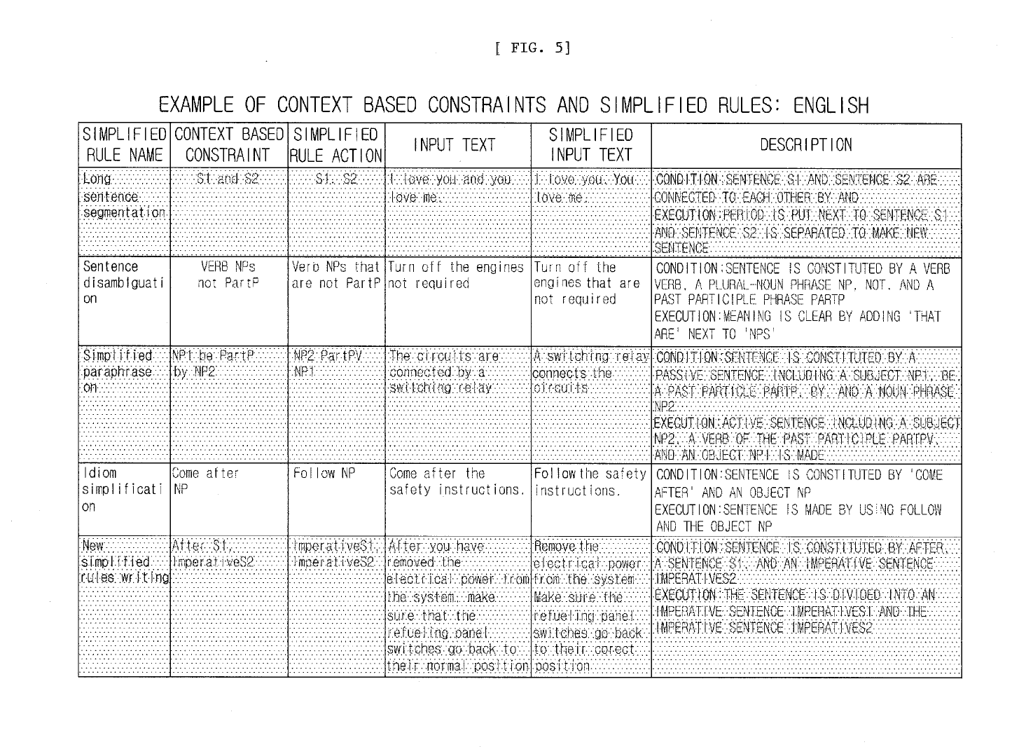

A detailed example of performing the rules will be described with reference to FIG. 5 which is a diagram showing the application example of FIG. 4.

Referring to FIG. 5, the rule of long sentence segmentation relates to, for example, parallel sentences and when an input which coincides with a context based constraint “if sentence S1 and sentence S2 are connected to each other by and” is inputted, “a period is put next to sentence S1 and sentence S2 is separated to make a new sentence”. For example, when an input text “I love you and you love me.” is inputted, the long sentence segmentation rule is applied, a simplified input text “I love you. You love me.” is outputted.

Next, the sentence disambiguation rule relates to, for example, equation disambiguation of a past participle phrase and when an input text which coincides with a context based constraint “if a sentence is constituted by a verb VERB, a plural-noun phrase NP, not, and a past participle phrase Part P” is inputted, “a meaning is clear by adding ‘that are’ next to ‘NPs’.” For example, when an input text “Turn off the engines not required.” is inputted, the sentence disambiguation rule is applied to output a simplified input text “Turn off the engines that are not required.”.

Next, the simplified paraphrase rule relates to, for example, a passive phrase and when an input text which coincides with a context based constraint “if a sentence is constituted by a passive sentence including a subject NP1, be, a past particle Part P, by, and a noun phrase NP2” is inputted, “an active sentence including a subject NP2, a verb of the past participle Part PV, and an object NP1 is made.” For example, when an input text “The circuits are connected by a switching relay.” Is inputted, the simplified paraphrase rule is applied to output a simplified input text “A switching relay connects the circuits.”.

Further, the idiom simplification rule relates to, for example, an idiom ‘come after’ and when an input text which is a context based constraint “if constitute by ‘come after’ and an object NP” is inputted, “a sentence is made by using follow and the object NP.” For example, when an input text “Come after the safety instructions.” is inputted, the idiom simplification rule is applied to output a simplified text “Follow the safety instructions.”.

Last, the new simplified rules writing rule can add a new rule when a rule to be applied does not exist and for example, when an input text which coincides with a context based constraint “if a sentence is constituted by after, a sentence S1, and an Imperative sentence ImperativeS2” is inputted, a rule “the sentence is divided into an imperative sentence ImperativeS1 and the imperative sentence ImperativeS2” does not exist in the simplified rule DB 207, the corresponding rule is additionally stored in the simplified rule DB to be applied. Therefore, for example, when an input text “After you have removed the electrical power from the system, make sure that the refueling panel switches go back to their normal position.” is inputted, a simplified input text “Remove the electrical power from the system. Make sure the refueling panel switches go back to their correct position.” may be outputted by the new added rule. Herein, when a rule to be applied does not exist, a criterion for determining whether the new rule needs to be added may be whether the structural change of the sentence to be of help to the second language speaker exists.

As such, the context based constraint and simplified rule applying unit 206 judges whether each of the context based constraints regarding a sentence length of an input text, a sentence pattern, an idiom, disambiguation, and the like is satisfied and applies each of the rules corresponding to the constraints according to the judgment result.

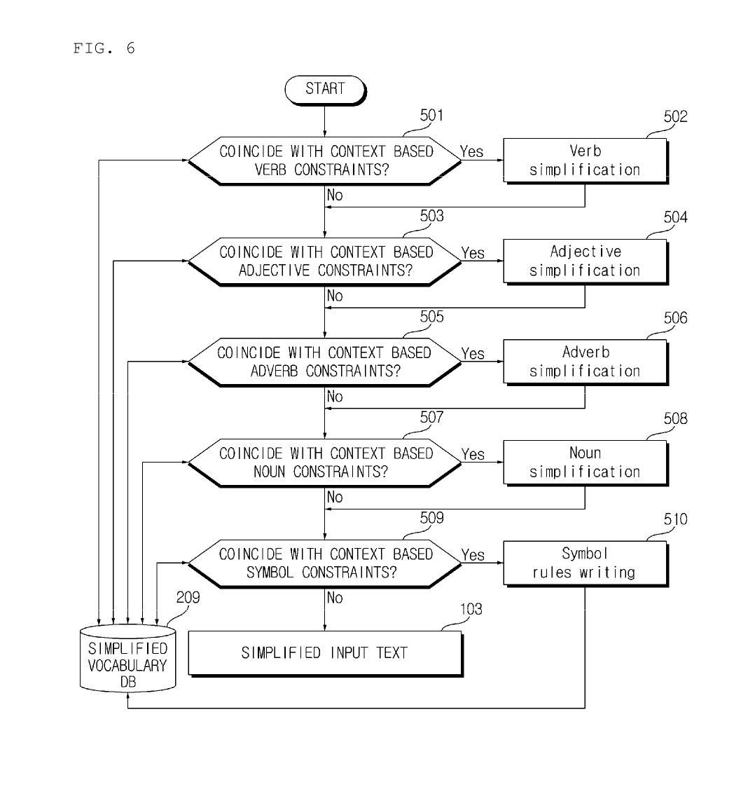

FIG. 6 is a detailed flowchart of a context based constraint and simplified vocabulary applying unit of FIG. 2. Referring to FIG. 6, the context based constraints and simplified vocabulary applying unit 208 replaces a complicated and ambiguous input text with a simplified and clear sentence by using the simplified rule DB 209 storing the context based constraints and the vocabularies corresponding thereto. In other words, at each judgment step of judging whether the inputted input text coincides with the context based constraints, the vocabularies of the input text which coincides with the constraints is substituted with easier and clearer vocabularies.

For example, at judging whether the input text coincides with the context based verb constraints (501), it is judged whether the vocabulary in the input text coincides with the verb constraints and when the vocabulary coincides with the verb constraints, verb simplification 502 is performed. If not, the next judgment step is performed.

Similarly, at judging whether the input text coincides with context based adjective constraints (503), it is judged whether the vocabulary in the input text coincides with the adjective constraints and when the vocabulary coincides with the adjective constraints, adjective simplification 504 is made. If not, the next judgment step is performed. Further, at judging whether the input text coincides with the context adverb constraints (505), when the vocabulary in the input text coincides with the adverb constraints, adverb simplification 506 is performed. If not, the next judgment step is performed.

Subsequently, at judging whether the input text coincides with the context based noun constraints (507), it is judged whether the vocabulary in the input text coincides with the noun constraints and when the vocabulary coincides with the noun constraints, noun simplification 508 is performed. If not, the next judgment step is performed. Further, at judging whether the input text coincides with the context based symbol constraints (509), it is judged whether the vocabulary in the input text coincides with the symbol constraints and when the vocabulary coincides with the symbol constraints, symbol simplification 510 is performed. If not, the simplified input text 103 which is the output of the language simplification processing unit 102 is inputted into the automatic translation unit 104. Herein, since the performing sequence of the rules is arbitrarily set merely for description of the exemplary embodiment, the performing sequence may be changed as necessary.

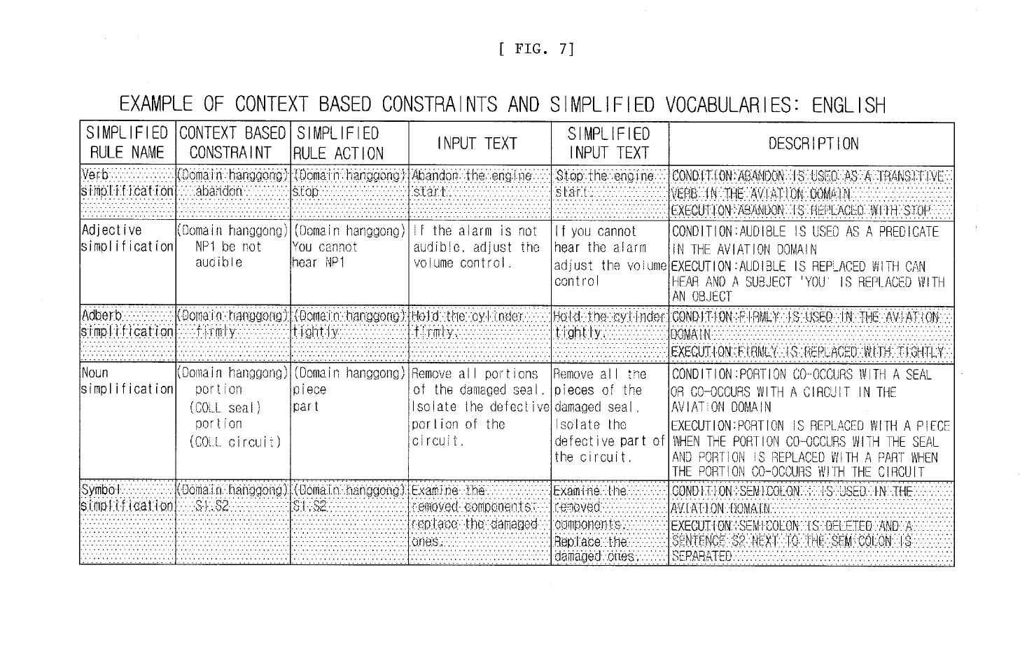

A detailed example of performing the rules will be described with reference to FIG. 7 which is a diagram showing the application example of FIG. 6.

Referring to FIG. 7, verb simplification relates to, for example, a verb ‘abandon’ in an aviation Domain and when an input text which coincides with a context based constraint “abandon is used as a transitive verb in the aviation Domain” is inputted, “abandon is replaced with stop”. For example, when an input text “Abandon the engine start.” is inputted, the verb simplification rule is applied to output a simplified input text “Stop the engine start.”.

Next, adjective simplification relates to, for example, an adjective ‘audible’ in the aviation Domain and when an input which coincides with a context based constraint “audible is used as a predicate in the aviation Domain” is inputted, “audible is replaced with can hear and a subject ‘You’ is replaced with an object.” For example, when an input text “If the alarm is not audible, adjust the volume control.” is inputted, the adjective simplification rule is applied to output a simplified input text “If you cannot hear the alarm, adjust the volume control.”.

Next, adverb simplification relates to, for example, an adverb ‘firmly’ in the aviation Domain and when an input text which coincides with a context based constraint “firmly is used in the aviation Domain is inputted, “firmly is “replaced with tightly”. For example, when an input text “Hold the cylinder firmly.” is inputted, the adverb simplification rule is applied to output a simplified input text “Hold the cylinder tightly.”.

Further, noun simplification relates to, for example, a noun portion in the aviation Domain and when an input text which coincides with a context based constraint “if a portion co-occurs with a seal or co-occurs with a circuit” is inputted, “the portion is replaced with a piece when the portion co-occurs with the seal.” “The portion is replaced with a part when the portion co-occurs with the circuit.” For example, when an input text “Remove all portions of the damaged seal. Isolate the defective portion of the circuit.” is inputted, the noun simplification rule is applied to output a simplified input text “Remove all the pieces of the damaged seal. Isolate the defective part of the circuit.”.

Last, symbol simplification relates to, for example, a semicolon in the aviation Domain and when an input text which coincides with a context based constraint “if the semicolon is used in the aviation Domain” is inputted, “the semicolon is deleted and a sentence S2 next to the semicolon is separated.” For example, when an input text “Examine the removed components; replace the damaged ones.” Is inputted, the symbol simplification rule is applied to output a simplified input text “Examine the removed components. Replace the damaged ones.”.

As such, the context based constraint and simplified vocabulary applying unit 208 judges whether each of context based constraints regarding parts-of-speech of vocabularies in the input text is satisfied and applies each of rules corresponding to the constraints according to the judgment result.

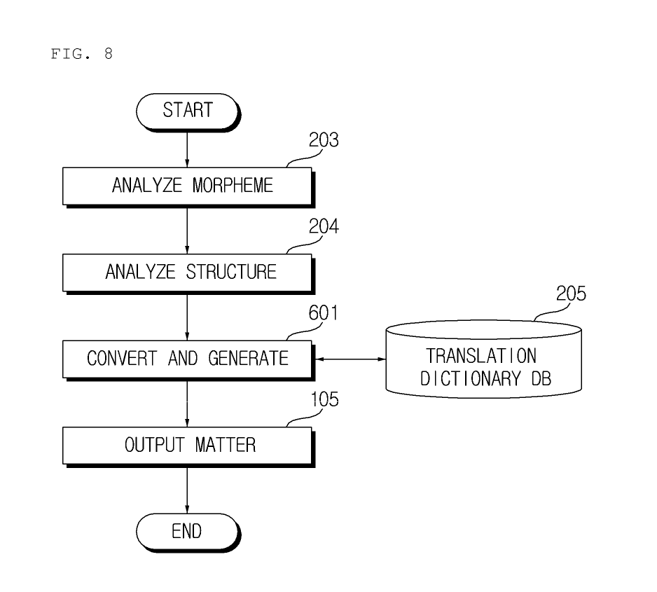

FIG. 8 is a configuration diagram of an automatic translation unit of FIG. 1. Referring to FIG. 8, the morpheme analyzing unit 203 and the structure analyzing unit 204 analyzes a morpheme and analyzes a sentence structure with respect to the inputted input text 101 or the simplified input text 103, respectively. In a converting and generating step (601), the analyzed input text 101 or the simplified input text 103 are converted and outputted to the output text 105 by using the translation dictionary DB 205.

An automatic translation device and a method thereof according to the present invention are not limited to only a device and a method of which original objects are automatic translation, but they can be applied to all technical fields that require predetermined functions on the basis of automatic translation.

As described above, the present invention can be implemented in predetermined other forms without departing from the spirit and essential feature of the present invention. Accordingly, the detailed description should not limitatively be analyzed but considered as exemplification in all viewpoints. The scope of the present invention should be determined by reasonable analysis of the appended claims and all modifications within the equivalent scope are included in the scope of the present invention. Further, claims which have no clear quotation relationship in the appended claims are combined with each other to configure an exemplary embodiment or may be included in a new claim by modification after application.

What is claimed is:

1. An automatic translation device, comprising:
a character string error correcting unit correcting an error of an input text;
a language simplification processing unit substituting the input text with a simplified input text by applying context based constraints and rules corresponding thereto; and
an automatic translation unit translating the simplified input text into an output text.

2. The automatic translation device of claim 1, wherein the language simplification processing unit further substitutes the input text with a simplified input text by applying context based constraints and vocabularies corresponding thereto.

3. The automatic translation device of claim 1, wherein the character string error correcting unit corrects at least one of a spelling error, a symbol error, an abbreviation error, a number error, a unit error, a name error, and other errors.

4. The automatic translation device of claim 1, wherein the language simplification processing unit judges whether the input text is satisfied with at least one of the context based constraints regarding a sentence length, a sentence pattern, an idiom, and disambiguation and applies each of rules corresponding thereto according to the judgment result.

5. The automatic translation device of claim 2, wherein the language simplification processing unit judges whether the input text is satisfied with at least one of context based constraints regarding parts-of-speech of vocabularies and applies each of vocabularies corresponding thereto according to the judgment result.

6. An automatic translation method, comprising:
correcting an error of an input text;
substituting the input text with a simplified input text by applying context based constraints and rules corresponding thereto; and
translating the simplified input text into an output text.

7. The automatic translation method of claim 6, wherein the substituting of the input text with the simplified input text further includes applying context based constraints and vocabularies corresponding thereto.

8. The automatic translation method of claim 6, wherein at the correcting of the error of an input text, at least one of a spelling error, a symbol error, an abbreviation error, a number error, a unit error, a name error, and other errors is corrected.

9. The automatic translation method of claim 6, wherein at the substituting of the input text into the simplified input text, judges whether the input text is satisfied with at least one of the context based constraints regarding a sentence length of the input text, a sentence pattern, an idiom, and disambiguation and applies each of the rules corresponding thereto according to the judgment result.

10. The automatic translation method of claim 7, wherein at the substituting of the input text into the simplified input text, judges whether the input text is satisfied with at least one of the context based constraints regarding parts-of-speech of vocabularies and applies each of the vocabularies corresponding thereto according to the judgment result.
